(19) United States
(12) Patent Application Publication
(10) Pub. No.: US 2024/0430051 A1
(43) Pub. Date: Dec. 26, 2024

(54) METHODS, DEVICES, AND COMPUTER READABLE MEDIUM FOR COMMUNICATION

(71) Applicant: NEC CORPORATION, Tokyo (JP)

(72) Inventors: Gang WANG, Beijing (CN); Yukai GAO, Beijing (CN)

(73) Assignee: NEC CORPORATION, Tokyo (JP)

(21) Appl. No.: 18/692,464

(22) PCT Filed: Sep. 15, 2021
(86) PCT No.: PCT/CN2021/118618

§ 371 Date: Mar. 15, 2024

(51) Int. Cl. H04L 5/00; H04L 1/1812; H04L 1/1829; H04W 56/00

(52) U.S. Cl. CPC H04L 5/0035; H04L 1/1854; H04L 5/0048; H04L 5/0064; H04W 56/005; H04L 1/1812

(57) ABSTRACT

According to embodiments, solutions on asynchronous MTRP transmission are proposed. A terminal device receives a first configuration from a network device. The first configuration indicates a time offset between a first transmission reception point (TRP) and a second TRP. The terminal device is able to support asynchronous multi-TRP (MTRP) transmissions from the first and second TRPs. The terminal device synchronizes with the first TRP. The terminal device performs at least one of: downlink reception or uplink transmission with the second TRP based on the time offset. In this way, it can align frame timing, slot boundary or symbol boundary at the terminal device.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. It is envisioned that multiple transmission and reception points (multi-TRPs) will be vital in 5G in order to improve reliability, coverage, and capacity performance through flexible deployment scenarios. For example, to be able to support the exponential growth in mobile data traffic in 5G and to enhance the coverage, the wireless devices are expected to access networks composed of multi-TRPs.

### SUMMARY

In general, example embodiments of the present disclosure provide a solution for communication.

In a first aspect, there is provided a method for communication. The communication method comprises: receiving, at a terminal device and from a network device, a first configuration indicating a time offset between a first transmission reception point (TRP) and a second TRP, wherein the terminal device is able to support asynchronous multi-TRP (MTRP) transmissions from the first and second TRPs; in accordance with a determination that the network device synchronizes with the first TRP, performing, at the terminal device, at least one of: downlink reception or uplink transmission with the second TRP based on the time offset.

In a second aspect, there is provided a method for communication. The communication method comprises: transmitting, at a network device and to a terminal device, a first configuration indicating a time offset between a first transmission reception point (TRP) and a second TRP, wherein the terminal device is able to support asynchronous multi-TRP (MTRP) transmissions from the first and second TRPs.

In a third aspect, there is provided a terminal device. The terminal device comprises a processing unit; and a memory coupled to the processing unit and storing instructions thereon, the instructions, when executed by the processing unit, causing the terminal device to perform acts comprising: receiving, from a network device, a first configuration indicating a time offset between a first transmission reception point (TRP) and a second TRP, wherein the terminal device is able to support asynchronous multi-TRP (MTRP) transmissions from the first and second TRPs; in accordance with a determination that the network device synchronizes with the first TRP, performing, at the terminal device, at least one of: downlink reception or uplink transmission with the second TRP based on the time offset.

In a fourth aspect, there is provided a network device. The network device comprises a processing unit; and a memory coupled to the processing unit and storing instructions thereon, the instructions, when executed by the processing unit, causing the network device to perform acts comprising: transmitting, to a terminal device, a first configuration indicating a time offset between a first transmission reception point (TRP) and a second TRP, wherein the terminal device is able to support asynchronous multi-TRP (MTRP) transmissions from the first and second TRPs.

In a fifth aspect, there is provided a computer readable medium having instructions stored thereon, the instructions, when executed on at least one processor, causing the at least one processor to carry out the method according to any one of the first aspect or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIG. 3 illustrates a schematic diagram of a time of arrival difference between different TRPs in accordance with an embodiment of the present disclosure;

FIG. 4 illustrates a schematic diagram of a time of arrival difference between different TRPs in accordance with an embodiment of the present disclosure;

FIG. 5 illustrates a schematic diagram of a time of arrival difference between different TRPs in accordance with an embodiment of the present disclosure;

FIG. 6 illustrates a schematic diagram of a time of arrival difference between different TRPs in accordance with an embodiment of the present disclosure;

FIG. 7 illustrates a schematic diagram of a time of arrival difference between different TRPs in accordance with an embodiment of the present disclosure;

FIG. 8 illustrates a schematic diagram of transmission regions in accordance with an embodiment of the present disclosure;

FIG. 9 is a flowchart of an example method in accordance with an embodiment of the present disclosure;

FIG. 10 is a flowchart of an example method in accordance with an embodiment of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. In the following description, the terms “terminal device”, “communication device”, “terminal”, “user equipment” and “UE” may be used interchangeably.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, a first information may be transmitted to the terminal device from the first network device and a second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “TRP” refers to an antenna array (with one or more antenna elements) available to the network device located at a specific geographical location. Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

Generally speaking, for uplink (UL) transmission, one TRP may correspond to one SRS resource set. As used herein, the term “single-TRP for UL” refers to that a single SRS resource set is used for performing related transmissions (such as, PUSCH transmissions), and the term “multi-TRP for UL” refers to that a plurality of SRS resource sets are used for performing related transmissions (such as, PUSCH transmissions). Alternatively or in addition, one TRP may correspond to one UL TCI state.

Generally speaking, for downlink transmission, one TRP may correspond to one CMR set. As used herein, the term “single-TRP” refers to that a single CMR set is used for performing related channel measurements, and the term “multi-TRP” refers to that a plurality of CMR sets is used for performing related channel measurements. Alternatively or in addition, one TRP may correspond to one Physical Cell Id, one CORESET Pool Index or one TCI state.

As used herein, the term ‘panel’ refers to a group of antennas, a group of antenna ports or a group of RF chains. One panel may correspond to a CSI-RS and/or SSB resource index, SRS resource set ID and/or SRS resource ID and/or SRS port ID. Alternatively or in addition, one panel may correspond to a list of supported UL ranks (number of UL transmission layers), a list of supported number of SRS antenna ports, a list of coherence types indicating a subset of ports.

In the following, the terms “PUSCH transmission”, “PUSCH transmission occasion”, “uplink transmission”, “PUSCH repetition”, “PUSCH occasion” and “PUSCH reception” can be used interchangeably. The terms “transmission”, “transmission occasion” and “repetition” can be used interchangeably. The terms “precoder”, “precoding”, “precoding matrix”, “beam”, “spatial relation information”, “spatial relation info”, “TPMI”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter” and “spatial relation” can be used interchangeably. The terms “SRI”, “SRS resource set index”, “UL TCI”, “UL spatial domain filter”, “UL beam”, “joint TCI” can be used interchangeably.

As mentioned above, the technology of “multi-TRP (MTRP)” has been proposed. Moreover, it is also propose to extend MTRP support to asynchronous scenario. In Release-16, it was agreed that ‘the UE may assume that the UE may receive DL transmission from multiple TRP within a CP with single/multiple FFT windows’, and solutions developed so far have been for synchronous TRPs only.

In asynchronous scenario, UE-observed time of arrival (TOA) difference of a second TRP from a first TRP is at least impacted by two factors: 1) MTRP Alignment error, e.g., time alignment error (TAE); 2) transmission path difference between different TRPs to the terminal device. If the TOA difference is larger than an orthogonal frequency division multiplexing (OFDM) symbol length, it may cause misaligned frame timing, e.g., misaligned frame boundary and/or slot boundary. If the TOA difference is larger than a cyclic prefix (CP) length, but smaller than an OFDM symbol length, it may cause inter-symbol interference (ISI). If the TOA difference is larger than a threshold for Non-coherent joint transmission (NCJT), but smaller than CP, there may be no MTRP (NCJT) gain. For example, in LTE/frequency range (FR)1 (15 KHz subcarrier spacing (SCS)), this threshold is [−0.5, 2] μs, the strict case in FR2 (120 KHz SCS) need to satisfy threshold as 0.5/8=0.0625 μs, which corresponds to the maximum support transmission path difference as 19 meters, even for the case without any MTRP alignment error, e.g., 0 TAE.

According to embodiments, solutions on asynchronous MTRP transmission are proposed. A terminal device receives a first configuration from a network device. The first configuration indicates a time offset between a first transmission reception point (TRP) and a second TRP. The terminal device is able to support asynchronous multi-TRP (MTRP) transmissions from the first and second TRPs. The terminal device synchronizes with the first TRP. The terminal device performs at least one of: downlink reception or uplink transmission with the second TRP based on the time offset. In this way, it can align frame timing, slot boundary or symbol boundary at the terminal device.

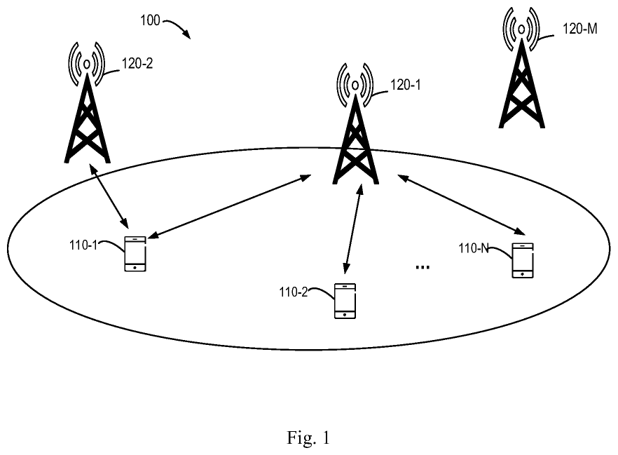

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number.

The communication system 100 further comprises a TRP 120-1, a TRP 120-2, . . . , a TRP 120-M, which can be collectively referred to as “TRP(s) 120.” The number M can be any suitable integer number. In the communication system 100, the TRP 120 and the terminal devices 110 can communicate data and control information to each other. The numbers of terminal devices and TRPs shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IOT and LTE-MTC, Integrated Access and Backhaul (TAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols.

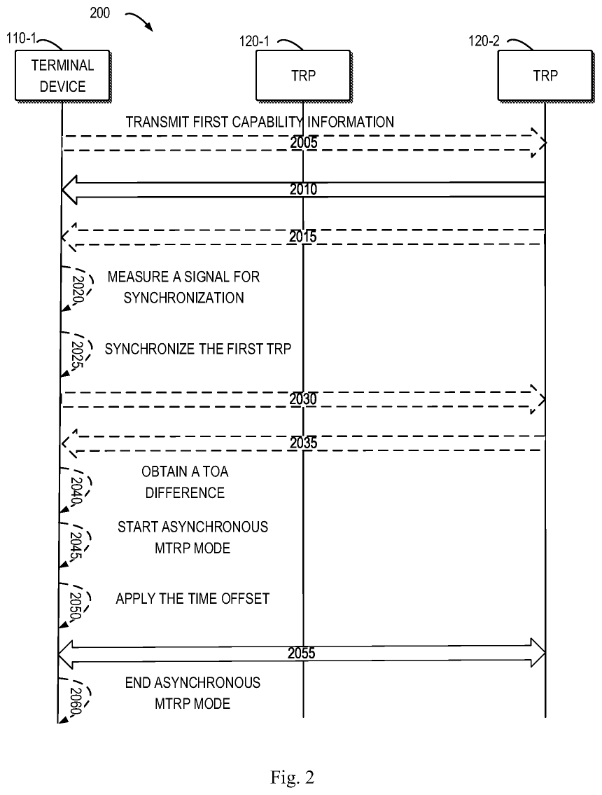

Embodiments of the present disclosure will be described in detail below. Reference is first made to FIG. 2, which shows a signaling chart illustrating process 200 between the terminal device and the network device according to some example embodiments of the present disclosure. Only for the purpose of discussion, the process 200 will be described with reference to FIG. 1. The process 200 may involve the terminal device 110-1, the TRP 120-1 (referred to as “first TRP” hereinafter), and the TRP 120-2 (referred to as “second TRP” hereinafter) in FIG. 1. The process 200 may also involve a network device. The network device can be an entity which includes TRP 120-1 and the TRP 120-2. It should be noted that the network device may also comprise other TRPs.

The terminal device 110-1 may transmit 2005 first capability information of the terminal device 110-1 to the network device. In some embodiments, the first capability information may indicate whether the terminal device 110-1 is able to support asynchronous MTRP transmissions from the TRP 120-1 and the TRP 120-2. Alternatively or in addition, the first capability information may indicate a maximum time offset that the terminal device 110-1 is able to support for the asynchronous MTRP transmissions. In some embodiments, the maximum time offset may be a maximum uplink (UL) transmission time offset. Alternatively or in addition, the maximum time offset may be a maximum downlink (DL) reception time offset.

The values of UE capability in the first capability information may depend on numerologies. For example, the terminal device 110-1 may report X time units as the maximum time offset supported for a first SCS, Y time units as the maximum time offset supported for a second SCS, . . . , respectively. Alternatively, the terminal device 110-1 may report X time units as the maximum time offset supported for a first SCS μ1, for a second SCS μ2, a value can be calculated by (2\hat{ }μ2)/2\hat{ }(μ1))*X or (2\hat{ }(−μ2)/2\hat{ }(−μl))*X. The time units can be symbols, milliseconds, and the like and the parameter “μ” represents the index for numerology. For example, μ=0 refers to 15 KHz SCS, μ=1 refers to 30 KHz SCS, μ=2 refers to 60 KHz SCS, μ=3 refers to 120 KHz SCS, μ=4 refers to 240 KHz SCS, μ=5 refers to 480 KHz SCS, μ=6 refers to 960 KHz SCS, . . . .

In some embodiments, the first capability information does not indicate whether the terminal device 110-1 is able to support the asynchronous MTRP transmissions nor indicate the aforementioned maximum time offset. In this case, the terminal device 110-1 does not support asynchronous MTRP transmissions. Alternatively, the first capability information may indicate that the terminal device 110-1 is able to support the asynchronous MTRP transmissions but does not indicate the aforementioned maximum time offset. In this case, the terminal device 110-1 may support a default value or any value configured. The default value or configured value may depend on numerologies.

The network device transmits 2010 a first configuration to the terminal device 110-1. The first configuration indicates a time offset between the TRP 120-1 and the TRP 120-2. The time offset may comprise an UL transmission time offset between the TRP 120-1 and the TRP 120-2 and/or a DL reception time offset between the TRP 120-1 and the TRP 120-2. The first configuration may be transmitted in any suitable signaling, for example, radio resource control (RRC) signaling, system information, broadcasting signaling, etc.

The exact value of the time offset may be related to at least one of the following: a MTRP alignment error, a MTRP transmission path difference, UE panel activation time, or UE panel switch time. For example, the time offset may be determined based on a time alignment error between the TRP 120-1 and the TRP 120-2. Alternatively or in addition, the time offset may be determined based on a transmission path difference between the TRP 120-1 and the TRP 120-2 to the terminal device 110-1. In other embodiments, the time offset may be determined based on a panel activation time of the terminal device 110-1. In a yet embodiment, the time offset can be determined based on a panel switch time of the terminal device 110-1. For example, the time offset can be a symbol-level offset. The time offset may be applied for a reference signal transmission/reception, downlink reception, and/or UL transmission, which will be described later.

In some embodiments, an enabler of the asynchronous MTRP transmission may be introduced. The enabler of the asynchronous MTRP transmission may be a higher layer parameter configured by the network device. The enabler may be set to “off” by default.

The value of the time offset may be related to the time alignment error (TAE). For example, the TAE may refer to a largest timing difference between any two signals belonging to different TRPs. In some embodiments, the TAE can be obtained by over the air (OTA) measurement. Alternatively, the TAE may be a manufacturing parameter.

In some embodiments, the value of the time offset may depend on numerologies. For example, the time offset may be configured as X time units for a first SCS, Y time units for a second SCS, . . . , respectively. Alternatively, the time offset may be configured as X time units for a first SCS μ1, for a second SCS μ2, a value can be calculated by =(2\hat{ }(μ2)/2\hat{ }(μ1))*X or (2\hat{ }(−μ2)/2\hat{ }(−μ1))*X. The time offset may be smaller than the reported UE capability. Alternatively, the time offset may be smaller than a specification-defined requirement. For example, the time offset may be smaller than a maximum transmission/reception timing difference for asynchronous MTRP. The terminal device 110-1 shall be capable of handling a relative transmission/reception timing difference between frame/subframe/slot/symbol timing boundary of a first TRP and the closest frame/subframe/slot/symbol timing boundary of a second TRP which is not synchronized with the first TRP. In some embodiments, the specification-defined requirement values may be numerology-dependent.

In other embodiments, the first configuration may comprise a reference signal (RS) configuration. Alternatively, the first configuration may comprise a transmission configuration indicator (TCI) configuration. In other embodiments, the first configuration may comprise a transmission scheme configuration.

In some embodiments, the network device may transmit 2015 a second configuration to the terminal device 110-1. The second configuration may indicate which signal for synchronization associated with the TRP 120-1 and/or TRP 120-2. For example, the signal for synchronization may be a synchronization signal block (SSB), a CSI-RS, a tracking RS or the like. The second configuration may indicate SSB grouping per TRP. In this case, there may be a different transmission power/timing/beamforming gain configured for a different SSB group.

The terminal device 110-1 may measure 2020 the signal for synchronization associated with the TRP 120-1 based on the second configuration. The terminal device 110-1 may synchronize 2025 with the TRP 120-1. For example, the synchronization may be performed based on the measurement result of the signal for synchronization. In an example embodiment, a first receiving (RX) panel of the terminal device 110-1 may be synchronized with the TRP 120-1.

In some embodiments, the terminal device 110-1 may select a reference TRP. In an example embodiment, the terminal device 110-1 may select the reference TRP based on the signal arrival time at the terminal device 110-1. For example, if the signal of the TRP 120-1 arrives earlier than the signal of the TRP 120-2, the TRP 120-1 may be selected as the reference TRP. In other embodiments, the terminal device 110-1 may determine the reference TRP based on signal strengths received at the terminal device 110-1. For example, if the signal of the TRP 120-1 is stronger than the signal of the TRP 120-2, the TRP 120-1 may be selected as the reference TRP. The signal strength may be a reference signal received power (RSRP). Alternatively, the signal strength may be a received signal strength indication (RSSI). In a situation where the terminal device 110-1 selects the reference TRP, the terminal device 110-1 may transmit 2030 a first indication regarding that the TRP 120-1 as the reference TRP.

Alternatively, the network device may select the reference TRP. In an example embodiment, the network device may select the reference TRP based on the signal arrival time at the network device. For example, if the signal arrives at the TRP 120-1 earlier than the TRP 120-2, the TRP 120-1 may be selected as the reference TRP. In this case, the network device may inform the terminal device 110-1 which TRP is the reference TRP. For example, the network device may transmit 2035 a third configuration regarding that the TRP 120-1 is the reference TRP. The third configuration may indicate that a TRP associated with a specific TCI state (for example, TCI state #0, TCI state with the lowest/highest TCI state ID) can be the reference TRP. Alternatively or in addition, the third configuration can indicate a TRP associated with a specific control resource set (CORESET) (for example, CORESET #0, CORESET with the lowest/highest CORESET ID) can be the reference TRP. In other embodiments, the third configuration can indicate a TRP associated with a specific CORESET pool index (for example, CORESET pool index=0) can be the reference TRP.

The terminal device 110-1 may obtain 2040 a TOA difference of the TRP 120-2 from the TRP 120-1. Alternatively, the second RX panel of the terminal device 110-1 may be synchronized with the TRP 120-2. In this case, the terminal device 110-1 may obtain 2040 a TOA difference of the TRP 120-1 from the TRP 120-2. In some embodiments, the terminal device 110-1 may transmit information about updated time offset configuration to the network device. In some embodiments, the network device may update time offset configuration based on the information reported from the terminal device.

The terminal device 110-1 may start 2045 an asynchronous MTRP mode. In some embodiments, the terminal device 110-1 may start the asynchronous MTRP mode based on an explicit indication from the network device. For example, the explicit indication may be transmitted in a RRC reconfiguration. The explicit indication may be transmitted in a MAC CE. Alternatively, the explicit indication may be transmitted in in DCI. In other embodiments, the terminal device 110-1 may start the asynchronous MTRP mode based on an implicit indication. For example, the asynchronous MTRP mode may be started based on a time offset configuration. In other embodiments, the asynchronous MTRP mode may be started based on a time offset update. In some embodiments, the start of the asynchronous MTRP mode can be triggered by terminal device request. Alternatively or in addition, the network device may start the asynchronous MTRP mode.

In some embodiments, the network device may start the asynchronous MTRP mode before the terminal device 110-1 starts the asynchronous MTRP mode. For example, the network device may transmit the explicit indication to the terminal device 110-1 after starting the asynchronous MTRP mode. In other embodiments, the network device may start the asynchronous MTRP mode based on the terminal request. Alternatively, the network device may start the asynchronous MTRP mode after the terminal device 110-1 starts the asynchronous MTRP mode. The network device and the terminal device 110-1 may start the asynchronous MTRP mode independently.

The terminal device 110-1 may apply 2050 the time offset. As mentioned above, the time offset may be applied for a reference signal transmission/reception, downlink reception and/or uplink transmission.

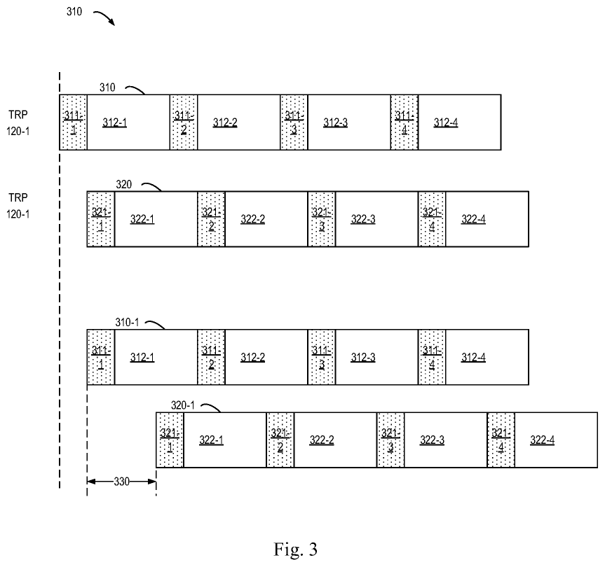

With the reference to FIG. 3, FIG. 3 shows a schematic diagram of the TOA difference. The TRP 120-1 can transmit the DL transmission 310 to the terminal device 110-1. The DL transmission 310 can comprise a first symbol which comprises a CP 311-1 and a non-CP part 312-1, a second symbol which comprises a CP 311-2 and a non-CP part 312-2, a third symbol which comprises a CP 311-3 and a non-CP part 312-3, and a fourth symbol which comprises a CP 311-4 and a non-CP part 312-4. The TRP 120-2 can transmit the DL transmission 320 to the terminal device 110-1. The DL transmission 320 can comprise a first symbol which comprises a CP 321-1 and a non-CP part 322-1, a second symbol which comprises a CP 321-2 and a non-CP part 322-2, a third symbol which comprises a CP 321-3 and a non-CP part 322-3, and a fourth symbol which comprises a CP 321-4 and a non-CP part 322-4. There is a TOA difference 330 between the DL transmission 310-1 received at the terminal device 110-1 and the DL transmission 320-1 received at the terminal device 110-1.

In some embodiments, if the TOA difference (for example, the TOA difference 330) between the TRP 120-1 and the TRP 120-2 exceeds a first threshold, the terminal device 110-1 may apply the time offset to a time-domain location of a reference signal associated with the TRP 120-2. The terminal device 110-1 may receive the reference signal associated with the TRP 120-2 based on the time-domain location with the time offset. The first threshold can be any suitable value, for example, an OFDM symbol length. Only as an example, channel state information reference signal (CSI-RS) can be used for beam management (BM), channel acquisition and tracking. The time-domain location l₀ of CSI-RS resource can be provided by the higher-layer parameters firstOFDMSymbolInTimeDomain, and defined relative to the start of a slot. Usually, the range is l₀∈{0,1, . . . , 13}, i.e., can be transmitted at any symbol. For CSI-RS transmission from an asynchronous TRP, the terminal device 110-1 may apply the time offset (represented as S_{offset}) to align the slot boundary. Table 1 below shows an example of an implementation. In Table 1 below, the reference TRP may refer to TRP 120-1 and the TRP which asynchronous with the reference TRP may refer to TRP 120-2.

TABLE 1
The reference point S₀ for starting symbol S is defined as S₀ = 0, for
CSI-RS transmission associated with the reference TRP.
The reference point S₀ for starting symbol S is defined as S₀ = S_{offset}, for
CSI-RS transmission associated with a TRP which is asynchronous with
the reference TRP.

In other embodiments, if the TOA difference (for example, the TOA difference 330) exceeds the first threshold, the terminal device 110-1 may apply the time offset to a UE channel state information (CSI) computation time. The terminal device 110-1 may compute the CSI report based on a measurement of a reference signal. The terminal device 110-1 may transmit the CSI report based on the CSI computation time with the time offset to the TR 120-2. For example, DCI can be used to trigger CSI-RS transmission and/or report, UE CSI computation time needs to be considered. Z and Z′ stands for physical downlink control channel (PDCCH) to CSI report time and CSI-RS to CSI report time respectively. If the TRP 120-1 uses DCI to trigger CSI-RS transmission from the TRP 120-2, or CSI-RS transmission and CSI report are associated with different TRPs, to meet UE capability of CSI computation time, the time offset (represented as S_{offset}) needs to be reserved in addition to Z and Z′. Table 2 below shows an example of an implementation.

```
TABLE 2
When the CSI request field on a DCI triggers a CSI report(s) on PUSCH, the UE shall
provide a valid CSI report for the n-th triggered report,
    if the first uplink symbol to carry the corresponding CSI report(s) including the effect
of the timing advance, starts no earlier than at symbol Z_{ref}, and
    if the first uplink symbol to carry the n-th CSI report including the effect of the timing
advance, starts no earlier than at symbol Z_{ref}′(n),
where Z_{ref} is defined as the next uplink symbol with its CP starting
    T_{proc,CSI} = (Z + Soffset)(2048 + 144) · κ2^{-μ} . T_{C} + T_{switch} after the end of the
last symbol of the PDCCH triggering the CSI report(s), and where Z_{ref}′(n), is defined as the
next uplink symbol with its CP starting
    T_{proc,CSI}′ = (Z′ + Soffset) (2048 + 144) . κ2^{-μ} . T_{C} after the end of the last
symbol in time of the latest of: aperiodic CSI-RS resource for channel measurements,
aperiodic CSI-IM used for interference measurements, and aperiodic NZP CSI-RS for
interference measurement, when aperiodic CSI-RS is used for channel measurement for
the n-th triggered CSI report, and where T_{switch} is defined in clause 6.4 of [3GPP TS 38.214
V16.6.0] and is applied only if Z₁ of table 5.4-1 is applied.
If the PUSCH indicated by the DCI is overlapping with another PUCCH or PUSCH, then
the CSI report(s) are multiplexed following the procedure in clause 9.2.5 of [3GPP TS
38.213 V16.6.0] and clause 5.2.5 of [3GPP TS 38.214 V16.6.0] when applicable, otherwise
the CSI report(s) are transmitted on the PUSCH indicated by the DCI.
When the CSI request field on a DCI triggers a CSI report(s) on PUSCH, if the first uplink
symbol to carry the corresponding CSI report(s) including the effect of the timing advance,
starts earlier than at symbol Z_{ref},
    the UE may ignore the scheduling DCI if no HARQ-ACK or transport block is
multiplexed on the PUSCH.
When the CSI request field on a DCI triggers a CSI report(s) on PUSCH, if the first uplink
symbol to carry the n-th CSI report including the effect of the timing advance, starts earlier
than at symbol Z_{ref}′(n),
    the UE may ignore the scheduling DCI if the number of triggered reports is one and
no HARQ-ACK or transport block is multiplexed on the PUSCH
    Otherwise, the UE is not required to update the CSI for the n-th triggered CSI report.
where, Z, Z′ and μ are defined as:
```

| | |
|---|---|
| $Z = {max}_{m = 0 , ... , M - 1} ( Z ( m ) ) and$ | ${Z}^{′} = {max}_{m = 0 , ... , M - 1} ( {Z}^{′} ( m ) ) , where M is the number of$ |

```
updated CSI report(s) according to Clause 5.2.1.6 of [3GPP TS 38.214 V16.6.0],
(Z(m), Z′ (m)) corresponds to the m-th updated CSI report and is defined as
    (Z₁, Z₁′ ) of the table 5.4-1 if the CSI is triggered without a PUSCH with either
transport block or HARQ-ACK or both when L = 0 CPUs are occupied (according to
Clause 5.2.1.6 of [3GPP TS 38.214 V16.6.0]) and the CSI to be transmitted is a single CSI
and corresponds to wideband frequency-granularity where the CSI corresponds to at most
4 CSI-RS ports in a single resource without CRI report and where CodebookType is set to
‘typeI-SinglePanel’ or where reportQuantity is set to ‘cri-RI-CQI’, or
    (Z₁, Z₁′) of the table 5.4-2 if the CSI to be transmitted corresponds to wideband
frequency-granularity where the CSI corresponds to at most 4 CSI-RS ports in a single
resource without CRI report and where CodebookType is set to ‘typeI-SinglePanel’ or
where reportQuantity is set to ‘cri-RI-CQI’, or
    (Z₁, Z₁′) of the table 5.4-2 if the CSI to be transmitted corresponds to wideband
frequency-granularity where the reportQuantity is set to ‘ssb-Index-SINR’, or
reportQuantity is set to ‘cri-SINR’, or
    (Z₃, Z₃′) of the table 5.4-2 if reportQuantity is set to ‘cri-RSRP’ or ‘ssb-Index-
RSRP’, where Xμ is according to UE reported capability beamReportTiming and KBₗ
is according to UE reported capability beamSwitchTiming as defined in [3GPP TS 38.306
v16.5.0], or
    (Z₂, Z₂′) of table 5.4-2 otherwise.
    μ of table 5.4-1 and table 5.4-2 corresponds to the min (μ_{PDCCH}, μ_{CSI-RS}, μ_{UL}) where
the μ_{PDCCH} corresponds to the subcarrier spacing of the PDCCH with which the DCI was
transmitted and μ_{UL} corresponds to the subcarrier spacing of the PUSCH with which the
CSI report is to be transmitted and μ_{CSI-RS} corresponds to the minimum subcarrier spacing
of the aperiodic CSI-RS triggered by the DCI
Table 5.4-1: CSI computation delay requirement 1
```

| | Z₁ [symbols] | |
|---|---|---|
| μ | Z₁ | Z₁′ |
| 0 | 10 | 8 |
| 1 | 13 | 11 |
| 2 | 25 | 21 |
| 3 | 43 | 36 |

Table 5.4-2: CSI computation delay requirement 2

| | Z₁ [symbols] | | Z₂ [symbols] | | Z₃ [symbols] | |
|---|---|---|---|---|---|---|
| μ | Z₁ | Z₁′ | Z₂′ | Z₂ | Z₃ | Z₃′ |
| 0 | 22 | 16 | 40 | 37 | 22 | X₀ |
| 1 | 33 | 30 | 72 | 69 | 33 | X₁ |
| 2 | 44 | 42 | 141 | 140 | min(44, X₂ + KB₁) | X₂ |
| 3 | 97 | 85 | 152 | 140 | min(97, X₃ + KB₂) | X₃ |

In an example embodiment, if the TOA difference (for example, the TOA difference 330) exceeds the first threshold, the terminal device 110-1 may apply the time offset to a beam switching timing for the asynchronous multi-TRP transmissions. The terminal device 110-1 may perform a beam switching based on the beam switching timing with the time offset. For example, beamSwitchTiming is a UE capability about the time required between PDCCH to CSI-RS. When CSI-RS transmission and the trigger DCI are associated with different TRPs, to meet UE capability of beam switch timing, the time offset (represented as S_{offset}) needs to be reserved in addition, i.e., beamSwitchTiming+S_{offset}.

In some embodiments, the time offset may be non-negative. Alternatively, if the time offset can be a negative value, the changes in UE CSI computation time and beamswitchingtiming may be only applied for the time offset not smaller than 0. In other word, the applied value can be a larger value between 0 and the value of the time offset if the value of the time offset is smaller than 0.

In other embodiments, if the TOA difference (for example, the TOA difference 330) exceeds the first threshold, the terminal device 110-1 may apply the time offset to a time-domain location of the downlink reception for the asynchronous multi-TRP transmissions. The terminal device 110-1 may perform the downlink reception based on the time-domain location with the time offset. For example, DCI field ‘Time domain resource assignment’ provides information containing slot offset K₀, the start and length indicator value (SLIV), and UE needs to find time-domain location of corresponding physical downlink shared channel (PDSCH). For PDSCH transmission from asynchronous TRP, the terminal device 110-1 may apply the time offset (represented as S_{offset}) to the starting symbol indicated in the SLIV to align frame/slot timing. Table 3 below shows an example of an implementation. In Table 3 below, the reference TRP may refer to TRP 120-1 and the TRP which is asynchronous with the reference TRP may refer to TRP 120-2.

TABLE 3
The reference point S₀ for starting symbol S is defined as S₀ = S_{offset}, for
PDSCH transmission associated with a TRP which is asynchronous with
the reference TRP

In some embodiments, if the TOA difference (for example, the TOA difference 330) exceeds the first threshold, the terminal device 110-1 may apply the time offset to physical downlink shared channel (PDSCH) processing time. The terminal device 110-1 may transmit a hybrid automatic repeat request (HARQ) feedback of the downlink transmission based on the PDSCH processing time with the time offset. For example, PDSCH to HARQ-ACK timing is related to UE PDSCH processing capabilityT_{proc,1}. If PDSCH and HARQ-ACK are associated with different TRPs, to meet UE capability of PDSCH processing time, the time offset (represented as S_{offset}) needs to be reserved in addition. Table 4 below shows an example of an implementation.

TABLE 4
T_{proc, 1} = (N₁ + d_{1, 1} + d₂ + Soffset)(2048 + 144) . κ2^{-μ} · T_{C} + Tₑₓₜ
N₁ is based on μ of table 5.3-1 and table 5.3-2 in 3GPP TS 38.214 V16.6.0] for UE
processing capability 1 and 2 respectively, where μ corresponds to the one of
(μ_{PDCCH}, μ_{PDSCH}, μ_{UL}) resulting with the largest T_{proc, 1}, where the μ_{PDCCH} corresponds
to the subcarrier spacing of the PDCCH scheduling the PDSCH, the μ_{PDSCH}
corresponds to the subcarrier spacing of the scheduled PDSCH, and μ_{UL} corresponds
to the subcarrier spacing of the uplink channel with which the HARQ-ACK is to be
transmitted, and k is defined in clause 4.1 of [3GPP TS 38.211 V16.6.0].
For operation with shared spectrum channel access, Tₑₓₜ is calculated according to
[3GPP TS 38.211 V16.6.0], otherwise T = 0.
If the PDSCH DM-RS position l₁ for the additional DM-RS in Table 7.4.1.1.2-3 in
clause 7.4.1.1.2 of [3GPP TS 38.211 V16.6.0] is l₁ = 12 then N_{1, 0} = 14 in Table 5.3-
1 of 3GPP TS 38.211 V16.6.0, otherwise N_{1, 0} = 13.
If the UE is configured with multiple active component carriers, the first uplink
symbol which carries the HARQ-ACK information further includes the effect of
timing difference between the component carriers as given in [3GPP TS 38.133
V16.5.0].
For the PDSCH mapping type A as given in clause 7.4.1.1 of [3GPP TS 38.211
V16.6.0]: if the last symbol of PDSCH is on the i-th symbol of the slot where i < 7,
then d_{1, 1} = 7 − i, otherwise d_{1, 1} = 0
If a PUCCH of a larger priority index would overlap with PUCCH/PUSCH of a
smaller priority index, d₂ for the PUCCH of a larger priority is set as reported by the
UE; otherwise d₂ = 0.
For UE processing capability 1: If the PDSCH is mapping type B as given in
clause 7.4.1.1 of [3GPP TS 38.211 V16.6.0], and
if the number of PDSCH symbols allocated is L = 3 then d_{1, 1} = 3 + min (d, 1) +
Soffset, where d is the number of overlapping symbols of the scheduling PDCCH
and the scheduled PDSCH.
if the number of PDSCH symbols allocated is 2, then d_{1, 1} = 3 + d + Soffset, where d
is the number of overlapping symbols of the scheduling PDCCH and the scheduled
PDSCH.
For UE processing capability 2: If the PDSCH is mapping type B as given in clause
7.4.1.1 of [3GPP TS 38.211 V16.6.0],
if the number of PDSCH symbols allocated is L ≥ 3 and L ≤ 6, then d_{1, 1} is the
number of overlapping symbols of the scheduling PDCCH and the scheduled
PDSCH + Soffset,
if the number of PDSCH symbols allocated is 2,
if the scheduling PDCCH was in a 3-symbol CORESET and the CORESET and the
PDSCH had the same starting symbol, then d_{1, 1} = 3 + Soffset,
otherwise d_{1, 1} is the number of overlapping symbols of the scheduling PDCCH and
the scheduled PDSCH + Soffset.
For the PDSCH mapping type A as given in clause 7.4.1.1 of [3GPP TS 38.211
V16.6.0]: if the last symbol of PDSCH is on the i-th symbol of the slot where i
Soffset <7, then d_{1, 1} = 7 − I + Soffset, otherwise d_{1, 1} = 0

In yet another embodiment, if the TOA difference (for example, the TOA difference 330) exceeds the first threshold, the terminal device 110-1 may apply the time offset to a time duration for Quasi Co-Location (QCL) for the asynchronous multi-TRP transmissions. For example, timeDurationForQCL is a UE capability about the time required between PDCCH and PDSCH for at least PDCCH decoding and QCL assumption switching. If scheduling PDCCH and scheduled PDSCH are associated with different TRPs, to meet UE capability of time duration for QCL, the time offset needs to be reserved in addition, i.e., timeDurationForQCL+Soffset.

In some embodiments, if the TOA difference (for example, the TOA difference 330) exceeds the first threshold, the terminal device 110-1 may perform a rate match around a symbol for the asynchronous multi-TRP transmissions with the time offset. For example, RateMatchPattern contains information element (IE) called symbolsInResourceBlock which is a symbol level bitmap in time domain. It indicates with a bit set to true that the UE shall rate match around the corresponding symbol(s). If PDCCH and PDSCH are associated with different TRPs, the terminal device 110-1 shall rate match around the corresponding symbol(s) with additional time offset for the non-reference TRP.

In other embodiments, the time offset may be non-negative. Alternatively, if the time offset can be a negative value, the changes in UE PDSCH processing capability and timeDurationForQCL may be only applied for the time offset not smaller than 0. In other word, the applied value can be a larger value between 0 and the value of the time offset if the value of the time offset is smaller than 0.

In another example embodiment, if the TOA difference exceeds the first threshold, the terminal device 110-1 may apply the time offset for a MTRP time division multiplexing (TDM) repetition mode. In this way, it can reserve the gap for TRP switch. In some embodiments, for intra-slot repetition, the repetition mode can be enabled by configuring ‘tdmSchemeA’, and the first symbol of the second PDSCH transmission occasion starts after K̅ symbols from the last symbol of the first PDSCH transmission occasion, where K̅ is a higher layer parameter configured by the network device. In this case, the terminal device 110-1 may consider the TOA difference and apply the time offset for MTRP intra-slot repetition. For example, the terminal device 110-1 may always apply the time offset in addition to K̅. Alternatively, the terminal device 110-1 may apply the larger one between the time offset and K̅. In some embodiments, if K̅ is not configured via the higher layer parameter by the network device, the terminal device 110-1 may assume K̅ equals the time offset. In other embodiments, the time offset may be non-negative. Alternatively, the applied value can be a larger value between 0 and the value of the time offset if the value of the time offset is smaller than 0.

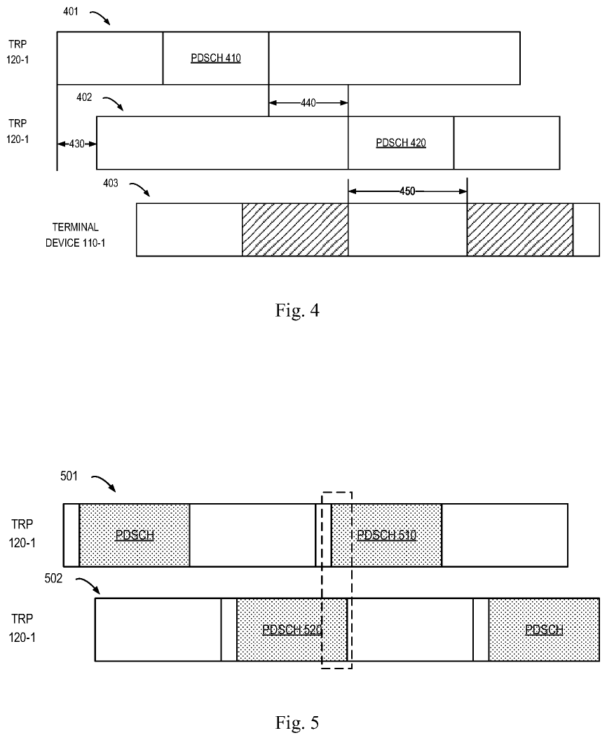

As shown in FIG. 4, the TRP 120-1 may transmit the DL transmission 401 which comprises the PDSCH 410, and the TRP 120-2 may transmit the DL transmission 402 which comprises the PDSCH 420. PDSCH 410 and PDSCH 420 can be associated with the same TB or different TBs. PDSCH 410 and PDSCH 420 can be associated with the same RV or different RVs of the same TB. There is a time offset 430 between the DL transmission 401 and the DL transmission 402. In some embodiments, the duration 450 between the last symbol of the PDSCH 410 and the first symbol of the PDSCH 420 may be a combination of the time offset 430 and the duration 440 which equals to K̅ symbols. In some embodiments, if K̅ is not configured, the terminal device 110-1 may assume K̅ equals the time offset 430. Alternatively, the duration 450 between the last symbol of the PDSCH 410 and the first symbol of the PDSCH 420 may be the larger one between the time offset 430 and the duration 440 which equals to K̅ symbols. Table5 below shows an example of an implementation. In Table 5 below, the first PDSCH transmission occasion may be associated with the reference TRP, e.g., TRP 120-1, and the second PDSCH transmission occasion may be associated with the TRP which is asynchronous with the reference TRP, e.g., TRP 120-2.

TABLE 5
If the UE is configured by the higher layers with a value K in
StartingSymbolOffsetK, it shall determine that the first symbol of the
second PDSCH transmission occasion starts after K + Soffset symbols
from the last symbol of the first PDSCH transmission occasion. If the
value K is not configured via the higher layer parameter
StartingSymbolOffsetK, K = Soffset shall be assumed by the UE.

Alternatively, for inter-slot repletion, the repetition mode can be enabled by configuration ‘repetitionNumber’, and the same SLIV is applied for all PDSCH transmission occasions across the repetitionNumber consecutive slots. In this case, the terminal device 110-1 may consider the TOA difference and apply the time offset for MTRP inter-slot repetition. In some embodiments, the terminal device 110-1 may always apply the time offset to the time-domain location of PDSCH transmission in slots associated with the TRP 120-2. Alternatively, the terminal device 110-1 may only apply the time offset when the gap between the last symbol of the n-th PDSCH transmission occasion and the first symbol of the (n+1)-th PDSCH transmission occasion is smaller than the time offset or a predefined time duration. For example, as shown in FIG. 5, if the gap between the PDSCH 510 and the PDSCH 520 is smaller than the time offset, the terminal device 110-1 may apply the time offset to the time-domain location of PDSCH transmission in slots associated with the TRP 120-2, to avoid the potential overlapping of PDSCH transmission from both TRPs. In other embodiments, the network device may configure different SLIV for PDSCH transmission associated with different TRPs. In some embodiments, the network device may configure different starting symbol for PDSCH transmission associated with different TRPs.

Alternatively or in addition, the network device may configure different length for PDSCH transmission associated with different TRPs. Table 6 below shows an example of an implementation. In Table 6 below, the first TCI state is associated with the reference TRP, e.g., TRP 120-1, and the second TCI state is associated with the TRP which asynchronous with the reference TRP, e.g., TRP 120-2.

TABLE 6
the same SLIV is applied for all PDSCH transmission occasions across the
slots associated with the first TCI state and SLIV with offset is applied
for all PDSCH transmission occasions across the slots associated with the
second TCI state

In an example embodiment, the terminal device 110-1 may reserve a measurement gap to avoid inter-TRP interference. In some embodiments, if the TOA difference between the TRP 120-1 and the TRP 120-2 exceeds a second threshold, or if the TOA difference exceeds a second threshold but is smaller than the first threshold, the terminal device 110-1 may receive a reference signal from the TRP 120-1 at a first symbol. In this case, the terminal device 110-1 may reserve the first symbol and a second symbol which is adjacent to the first symbol as unavailable for the downlink transmission associated with the TRP 120-2. The second threshold may be any suitable value, for example, a cyclic prefix (CP) length. The reference signal can be any suitable types of signals, for example, a CSI-RS or a demodulation reference signal (DMRS). In some other embodiments, if the TOA difference between the TRP 120-1 and the TRP 120-2 exceeds a second threshold, or if the TOA difference exceeds a second threshold but is smaller than the first threshold, the terminal device 110-1 may transmit/receive a physical channel/signal to/from the TRP 120-1 at a first symbol and it may reserve the first symbol and a second symbol which is adjacent to the first symbol as unavailable for transmit/receive a physical channel/signal to/from TRP 120-2. A physical channel may be any suitable channel, for example, one or many of uplink/downlink control channel, uplink/downlink shared channel, uplink/downlink data channel, random access channel, broadcast channel. A physical signal may be any signal, for example, one or many of synchronization signal, CSI-RS, DMRS, Sounding RS, Phase tracking TRS, Positioning RS.

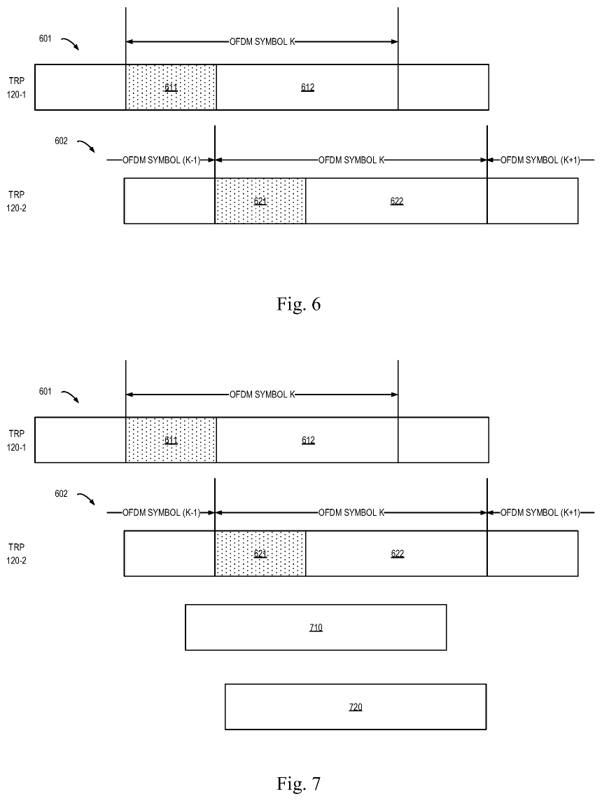

For example, if the transmission of the TRP 120-1 and the transmission of the TRP 120-2 need to be orthogonal, the transmission of the TRP 120-2 on the OFDM symbols (k±N) may also be impacted by the transmission of the TRP 120-1 on the OFDM symbol k. The N can be any suitable integer number. Thus, the OFDM symbol k and the OFDM symbol (k±N) may be reserved as unavailable for the downlink transmission associated with the TRP 120-2. As shown in FIG. 6, the transmission 601 of the TRP 120-1 is on the OFDM symbol k. The OFDM symbol k of the transmission 601 may comprise a CP 611 and a non-CP part 612. In this case, only as an example, the OFDM symbols (k−1) and k may be reserved as unavailable for the downlink transmission associated with the TRP 120-2. The OFDM symbol k of the transmission 6012 may comprise a CP 621 and a non-CP part 622. In this way, it avoids ISI.

In some embodiments, the terminal device 110-1 may transmit, to the network device, second capability information of the terminal device 110-1. The second capability information may indicate a first maximum supported number (represented as F1) of fast Fourier transform (FFT) windows. Alternatively or in addition, the second capability information may indicate a second number (represented as F2) of FFT windows supported simultaneously by the terminal device 110-1. For example, the terminal device 110-1 may be able support four different FFT windows but can only apply two FFT windows at the same time. In this case, the terminal device 110-1 may attempt four times for measuring a signal within two time units. Alternatively or in addition, the second capability information is related to the number of receive panels equipped at terminal device 110-1. Alternatively or in addition, the second capability information is related to the number of maximum supported simultaneously active receive panels equipped at terminal device 110-1.

In an example embodiment, if multiple FFT windows are applied to eliminate ISI at the terminal device 110-1 side, the measurement period can be related to the number of FFT windows. In this way, the terminal device 110-1 can support multiple FFT windows to mitigate ISI. For example, for a RS measurement, a longer measurement period can be expected since the terminal device 110-1 may be only capable to apply one FFT window at one time. As shown in FIG. 7, the terminal device 110-1 may not able to apply the FFT window 710 or the FFT window 720 at the same time. The terminal device 110-1 may apply a multiplying factor to reference signal measurement period. The multiplying factor is related to UE capability on FFT windows, for example, the ratio between maximum supported number of fast Fourier transform (FFT) windows and maximum supported number of simultaneously applied fast Fourier transform (FFT) windows. The factor of F is multiplied to allow the terminal device 110-1 to try a different FFT window at a different time, for example, F=F1/F2. The factor can be applied for layer 1 RSRP measurement or layer 1 signal interference noise ratio (L1-SINR) measurement. Table 7 below shows an example of an implementation. In Table 7 below, M, P, N are scaling factors defined as measurement requirements for different reference signal configurations in [3GPP TS38.133 V16.5.0]. For example, M=3, P=1, N=1 for measurement period of a periodic CSI-RS without receive beam sweeping.

TABLE 7

| | |
|---|---|
| Configuration | T_{L1-RSRP}_{_{—}}_{Measurement}_{_{—}}_{Period}_{_{—}}_{CSI-RS} (ms) |
| non-DRX | max(T_{Report}, ceil(M*P*N*F)*T_{CSI-RS}) |
| DRX | max(T_{Report}, ceil(1.5*M*P*N*F)*max(T_{DRX}, T_{CSI-RS})) |
| cycle ≤320 ms | |
| DRX | ceil(M*P*N*F)*TDRX |
| cycle >320 ms | |

Note 1:
T_{CSI-RS} is the periodicity of CSI-RS configured for L1-RSRP measurement. T_{DRX} is the DRX cycle length. T_{Report} is configured periodicity for reporting.
Note 2:
the requirements are applicable provided that the CSI-RS resource configured for L1-RSRP measurement is transmitted with Density = 3.

In some embodiments, the terminal device 110-1 may transmit third capability information to the network device. The third capability information may indicate whether the terminal device is able to support asynchronous MTRP non-coherent joint transmission (NCJT). In some embodiments, the third capability information may indicate whether the terminal device is able to support asynchronous MTRP CJT. Alternatively, the third capability information may indicate whether the terminal device is able to support fallback to a reliability transmission in accordance with a determination that the TOA difference between the TRP 120-1 and the TRP 120-2 exceeds a threshold. A reliability transmission can be transmission in aforementioned MTRP TDM repetition mode. In this case, in some embodiments, the terminal device 110-1 may transmit third indication which indicates the TOA difference between the TRP 120-1 and the TRP 120-2. Alternatively, the network device may measure the uplink transmission. It requires that the terminal device 110-1 transmits a UL signal in a synchronized way, so the network (multiple TRPs) can obtain the accurate propagation delays (respectively) from the terminal device 110-1. For example, the terminal device 110-1 may transmit UL channels/signals via the same timing advance (TA). Alternatively, the terminal device 110-1 may notify the network the applied difference between TAs used for UL transmissions by different UE transmitting (TX) panels.

The terminal device 110-1 may determine a transmission mode based on the TOA difference. The transmission mode can comprise one of: a CJT transmission mode, a NCJT transmission node or a reliability transmission mode. For example, adaptive transmissions may be in different regions. Depending on maximum acceptable path difference from different TRPs to the terminal device 110-1, region can benefit from MTRP (NCJT) and region (for example, region 810) can be benefit form MTRP (reliability) may be different. In another example, the adopted transmission mode depends on the value of ToA difference, CJT is adopted when ToA difference belongs to a first range, NCJT is adopted when ToA difference belongs to a second range, TDM repetition is adopted when ToA difference belongs to a third range. In some embodiments, transmission mode can be updated explicitly, for example, via dedicated signaling to start CJT/NCJT/reliability transmission. In some embodiments, transmission mode can be updated implicitly, for example, via predefined, the network device configured or the terminal device suggested corresponding relationship between transmission modes and TOA difference.

The terminal device 110-1 performs 2055 a downlink reception and/or uplink transmission with the TRP 120-2 based on the time offset. In some embodiments, the terminal device may perform downlink reception or uplink transmission with the asynchronous TRP based on the time offset for one or more of the following: (1) HARQ ACK slot offset in the case that DL DCI does not schedule PDSCH but requests HARQ-ACK, for example, semi-persistent (SPS) release DCI, SCell dormancy indication, requesting Type-3 HARQ-Ack codebook; (2) SPS PDSCH cancelation timeline; (3) PUCCH resource overriding timeline; (4) starting drx-InacitivityTimer; (5) timeline to send PRACH in response to PDCCH order; (6) PDSCH/AP-CSI-RS reception preparation time with cross carrier scheduling with different SCS's for PDCCH and PDSCH/AP-CSI-RS, i.e., minimum scheduling delay Npdsch and Ncsirs; (7) Power headroom (PHR) timeline conditions for virtual versus actual PHR; (8) Transmit Power Control (TPC) application time window to determine whether a TPC command is applicable or not; (9) CSI Processing Unit occupation duration for aperiodic CSI; or (9) determining the most recent transmission of SRS resource(s) identified by the SRI.

The terminal device 110-1 may end 2060 the asynchronous MTRP mode. In some embodiments, the terminal device 110-1 may end the asynchronous MTRP mode based on an explicit indication from the network device. For example, the explicit indication may be transmitted in a RRC reconfiguration. The explicit indication may be transmitted in a MAC CE. Alternatively, the explicit indication may be transmitted in DCI. In other embodiments, the terminal device 110-1 may end the asynchronous MTRP mode based on an implicit indication. For example, the asynchronous MTRP mode may be ended based on a time offset configuration. In other embodiments, the asynchronous MTRP mode may be ended based on a time offset update. In some embodiments, ending the asynchronous MTRP mode can be triggered by terminal device request. Alternatively or in addition, the network device may start the asynchronous MTRP mode.

In some embodiments, the network device may start the asynchronous MTRP mode before the terminal device 110-1 starts the asynchronous MTRP mode. For example, the network device may transmit the explicit indication to the terminal device 110-1 after starting the asynchronous MTRP mode. In other embodiments, the network device may start the asynchronous MTRP mode based on the terminal request. Alternatively, the network device may start the asynchronous MTRP mode after the terminal device 110-1 starts the asynchronous MTRP mode. The network device and the terminal device 110-1 may start the asynchronous MTRP mode independently.

FIG. 9 shows a flowchart of an example method 900 in accordance with an embodiment of the present disclosure. The method 900 can be implemented at any suitable devices. Only for the purpose of illustrations, the method 900 can be implemented at a terminal device 110-1 as shown in FIG. 1.

In some embodiments, the terminal device 110-1 may transmit first capability information of the terminal device 110-1 to the network device. In some embodiments, the first capability information may indicate whether the terminal device 110-1 is able to support asynchronous MTRP transmissions from the TRP 120-1 and the TRP 120-2. Alternatively or in addition, the first capability information may indicate a maximum time offset that the terminal device 110-1 is able to support for the asynchronous MTRP transmissions. In some embodiments, the maximum time offset may be a maximum UL transmission time offset. Alternatively or in addition, the maximum time offset may be a maximum downlink (DL) reception time offset.

The values of UE capability in the first capability information may depend on numerologies. For example, the terminal device 110-1 may report X time units as the maximum time offset supported for a first SCS, Y time units as the maximum time offset supported for a second SCS, . . . , respectively. Alternatively, the terminal device 110-1 may report X time units as the maximum time offset supported for a first SCS μ1, for a second SCS μ2, a value can be calculated by (2\hat{ }(μ2)/2\hat{ }(μ1))*X or (2\hat{ }(−μ2)/2\hat{ }(−μ1))*X. The time units can be symbols, milliseconds, and the like and the parameter “p” represents the index for numerology. For example, μ=0 refers to 15 KHz SCS, μ=1 refers to 30 KHz SCS, μ=2 refers to 60 KHz SCS, μ=3 refers to 120 KHz SCS, μ=4 refers to 240 KHz SCS, μ=5 refers to 480 KHz SCS, μ=6 refers to 960 KHz SCS, . . . .

In some embodiments, the first capability information does not indicate whether the terminal device 110-1 is able to support the asynchronous MTRP transmissions nor indicate the aforementioned maximum time offset. In this case, the terminal device 110-1 does not support asynchronous MTRP transmissions. Alternatively, the first capability information may indicate that the terminal device 110-1 is able to support the asynchronous MTRP transmissions but does not indicate the aforementioned maximum time offset. In this case, the terminal device 110-1 may support a default value or any value configured. The default value or configured value may depend on numerologies.

At block 910, the terminal device 110-1 receives a first configuration form the network device. The first configuration indicates a time offset between the TRP 120-1 and the TRP 120-2. The time offset may comprise an UL transmission time offset between the TRP 120-1 and the TRP 120-2 and/or a DL reception time offset between the TRP 120-1 and the TRP 120-2. The first configuration may be transmitted in any suitable signaling, for example, radio resource control (RRC) signaling, system information, broadcasting signaling, etc.

The exact value of the time offset may be related to at least one of the following: a MTRP alignment error, a MTRP transmission path difference, UE panel activation time, or UE panel switch time. For example, the time offset may be determined based on a time alignment error between the TRP 120-1 and the TRP 120-2 to the terminal device 110-1. Alternatively or in addition, the time offset may be determined based on a transmission path difference between the TRP 120-1 and the TRP 120-2. In other embodiments, the time offset may be determined based on a panel activation time of the terminal device 110-1. In a yet embodiment, the time offset can be determined based on a panel switch time of the terminal device 110-1. For example, the time offset can be a symbol-level offset. The time offset may be applied for a reference signal transmission/reception, downlink reception, and/or UL transmission, which will be described later.

In some embodiments, an enabler of the asynchronous MTRP transmission may be introduced. The enabler of the asynchronous MTRP transmission may be a higher layer parameter configured by the network device. The enabler may be set to “off” by default.

The value of the time offset may be related to the time alignment error (TAE). For example, the TAE may refer to a largest timing difference between any two signals belonging to different TRPs. In some embodiments, the TAE can be obtained by over the air (OTA) measurement. Alternatively, the TAE may be a manufacturing parameter.

In some embodiments, the value of the time offset may depend on numerologies. For example, the time offset may be configured as X time units for a first SCS, Y time units for a second SCS, . . . , respectively. Alternatively, the time offset may be configured as X time units for a first SCS μ1, for a second SCS μ2, a value can be calculated by =(2\hat{ }(μ2)/2\hat{ }(μ1))*X or (2\hat{ }(−μ2)/2\hat{ }(−μ1))*X. The time offset may be smaller than the reported UE capability. Alternatively, the time offset may be smaller than a specification-defined requirement. For example, the time offset may be smaller than a maximum transmission/reception timing difference for asynchronous MTRP. The terminal device 110-1 shall be capable of handling a relative transmission/reception timing difference between frame/subframe/slot/symbol timing boundary of a first TRP and the closest frame/subframe/slot/symbol timing boundary of a second TRP which is not synchronized with the first TRP. In some embodiments, the specification-defined requirement values may be numerology-dependent.

In other embodiments, the first configuration may comprise a reference signal (RS) configuration. Alternatively, the first configuration may comprise a transmission configuration indicator (TCI) configuration. In other embodiments, the first configuration may comprise a transmission scheme configuration.

In some embodiments, the terminal device 110-1 may receive, from the network device, a second configuration to the terminal device 110-1. The second configuration may indicate which signal for synchronization associated with the TRP 120-1 and/or TRP 120-2. For example, the signal for synchronization may be a synchronization signal block (SSB), a CSI-RS, a tracking RS or the like. The second configuration may indicate SSB grouping per TRP. In this case, there may be a different transmission power/timing/beamforming gain configured for a different SSB group. In some embodiments, the terminal device 110-1 may measure the signal for synchronization associated with the TRP 120-1 based on the second configuration.

In some embodiments, the terminal device 110-1 may synchronize with the TRP 120-1. For example, the synchronization may be performed based on the measurement result of the signal for synchronization. In an example embodiment, a first receiving (RX) panel of the terminal device 110-1 may be synchronized with the TRP 120-1.

In some embodiments, the terminal device 110-1 may select a reference TRP. In an example embodiment, the terminal device 110-1 may select the reference TRP based on the signal arrival time at the terminal device 110-1. For example, if the signal of the TRP 120-1 arrives earlier than the signal of the TRP 120-2, the TRP 120-1 may be selected as the reference TRP. In other embodiments, the terminal device 110-1 may determine the reference TRP based on signal strengths received at the terminal device 110-1. For example, if the signal of the TRP 120-1 is stronger than the signal of the TRP 120-2, the TRP 120-1 may be selected as the reference TRP. The signal strength may be a reference signal received power (RSRP). Alternatively, the signal strength may be a received signal strength indication (RSSI). In a situation where the terminal device 110-1 selects the reference TRP, the terminal device 110-1 may transmit a first indication regarding that the TRP 120-1 as the reference TRP.

Alternatively, the network device may select the reference TRP. In an example embodiment, the network device may select the reference TRP based on the signal arrival time at the network device. For example, if the signal arrives at the TRP 120-1 earlier than the TRP 120-2, the TRP 120-1 may be selected as the reference TRP. In this case, the network device may inform the terminal device 110-1 which TRP is the reference TRP. For example, the terminal device 110-1 may receive a third configuration regarding that the TRP 120-1 is the reference TRP. The third configuration may indicate that a TRP associated with a specific TCI state (for example, TCI state #0, TCI state with the lowest/highest TCI state ID) can be the reference TRP. Alternatively or in addition, the third configuration can indicate a TRP associated with a specific control resource set (CORESET) (for example, CORESET #0, CORESET with the lowest/highest CORESET ID) can be the reference TRP. In other embodiments, the third configuration can indicate a TRP associated with a specific CORESET pool index (for example, CORESET pool index=0) can be the reference TRP.

The terminal device 110-1 may obtain a TOA difference of the TRP 120-2 from the TRP 120-1. Alternatively, the second RX panel of the terminal device 110-1 may be synchronized with the TRP 120-2. In this case, the terminal device 110-1 may obtain a TOA difference of the TRP 120-1 from the TRP 120-2. In some embodiments, the terminal device 110-1 may transmit information about updated time offset configuration to the network device. In some embodiments, the network device may update time offset configuration based on the information reported from the terminal device.

The terminal device 110-1 may start an asynchronous MTRP mode. In some embodiments, the terminal device 110-1 may start the asynchronous MTRP mode based on an explicit indication from the network device. For example, the explicit indication may be transmitted in a RRC reconfiguration. The explicit indication may be transmitted in a MAC CE. Alternatively, the explicit indication may be transmitted in in DCI. In other embodiments, the terminal device 110-1 may start the asynchronous MTRP mode based on an implicit indication. For example, the asynchronous MTRP mode may be started based on a time offset configuration. In other embodiments, the asynchronous MTRP mode may be started based on a time offset update. In some embodiments, the start of the asynchronous MTRP mode can be triggered by UE terminal device request.

The terminal device 110-1 may apply the time offset. In some embodiments, if the TOA difference between the TRP 120-1 and the TRP 120-2 exceeds a first threshold, the terminal device 110-1 may apply the time offset to a time-domain location of a reference signal associated with the TRP 120-2. The terminal device 110-1 may receive the reference signal associated with the TRP 120-2 based on the time-domain location with the time offset. The first threshold can be any suitable value, for example, an OFDM symbol length. Only as an example, channel state information reference signal (CSI-RS) can be used for beam management (BM), channel acquisition and tracking. The time-domain location l₀ of CSI-RS resource can be provided by the higher-layer parameters firstOFDMSymbolInTimeDomain, and defined relative to the start of a slot. Usually, the range is l₀∈{0,1, . . . , 13}, i.e., can be transmitted at any symbol. For CSI-RS transmission from an asynchronous TRP, the terminal device 110-1 may apply the time offset (represented as S_{offset}) to align the slot boundary.

In other embodiments, if the TOA difference exceeds the first threshold, the terminal device 110-1 may apply the time offset to a UE channel state information (CSI) computation time. The terminal device 110-1 may compute the CSI report based on a measurement of a reference signal. The terminal device 110-1 may transmit the CSI report based on the CSI computation time with the time offset to the TRP 120-2. For example, DCI can be used to trigger CSI-RS transmission and/or report, UE CSI computation time needs to be considered. Z and Z′ stands for physical downlink control channel (PDCCH) to CSI report time and CSI-RS to CSI report time respectively. If the TRP 120-1 uses DCI to trigger CSI-RS transmission from the TRP 120-2, or CSI-RS transmission and CSI report are associated with different TRPs, to meet UE capability of CSI computation time, the time offset (represented as S_{offset}) needs to be reserved in addition to Z and Z′.

In an example embodiment, if the TOA difference exceeds the first threshold, the terminal device 110-1 may apply the time offset to a beam switching timing for the asynchronous multi-TRP transmissions. The terminal device 110-1 may perform a beam switching based on the beam switching timing with the time offset. For example, beamSwitchTiming is a UE capability about the time required between PDCCH to CSI-RS. When CSI-RS transmission and the trigger DCI are associated with different TRPs, to meet UE capability of beam switch timing, the time offset (represented as S_{offset}) needs to be reserved in addition, i.e., beamSwitchTiming+S_{offset}.

In some embodiments, the time offset may be non-negative. Alternatively, if the time offset can be a negative value, the changes in UE CSI computation time and beamswitchingtiming may be only applied for the time offset not smaller than 0. In other word, the applied value can be a larger value between 0 and the value of the time offset if the value of the time offset is smaller than 0.

In other embodiments, if the TOA difference exceeds the first threshold, the terminal device 110-1 may apply the time offset to a time-domain location of the downlink reception for the asynchronous multi-TRP transmissions. The terminal device 110-1 may perform the downlink reception based on the time-domain location with the time offset. For example, DCI field ‘Time domain resource assignment’ provides information containing slot offset K₀, the start and length indicator value (SLIV), and UE needs to find time-domain location of corresponding physical downlink shared channel (PDSCH). For PDSCH transmission from asynchronous TRP, the terminal device 110-1 may apply the time offset (represented as S_{offset}) to the starting symbol indicated in the SLIV to align frame/slot timing.

In some embodiments, if the TOA difference exceeds the first threshold, the terminal device 110-1 may apply the time offset to physical downlink shared channel (PDSCH) processing time. The terminal device 110-1 may transmit a hybrid automatic repeat request (HARQ) feedback of the downlink transmission based on the PDSCH processing time with the time offset. For example, PDSCH to HARQ-ACK timing is related to UE PDSCH processing capabilityT_{proc,1}. If PDSCH and HARQ-ACK are associated with different TRPs, to meet UE capability of PDSCH processing time, the time offset (represented as S_{offset}) needs to be reserved in addition.

In yet another embodiment, if the TOA difference (for example, the TOA difference 330) exceeds the first threshold, the terminal device 110-1 may apply the time offset to a time duration for Quasi Co-Location (QCL) for the asynchronous multi-TRP transmissions. For example, timeDurationForQCL is a UE capability about the time required between PDCCH and PDSCH for at least PDCCH decoding and QCL assumption switching. If scheduling PDCCH and scheduled PDSCH are associated with different TRPs, to meet UE capability of time duration for QCL, the time offset needs to be reserved in addition, i.e., timeDurationForQCL+Soffset.

In some embodiments, if the TOA difference exceeds the first threshold, the terminal device 110-1 may perform a rate match around a symbol for the asynchronous multi-TRP transmissions with the time offset. For example, RateMatchPattern contains information element (IE) called symbolslnResourceBlock which is a symbol level bitmap in time domain. It indicates with a bit set to true that the UE shall rate match around the corresponding symbol(s). If PDCCH and PDSCH are associated with different TRPs, the terminal device 110-1 shall rate match around the corresponding symbol(s) with additional time offset for the non-reference TRP.

In other embodiments, the time offset may be non-negative. Alternatively, if the time offset can be a negative value, the changes in UE PDSCH processing capability and timeDurationForQCL may be only applied for the time offset not smaller than 0. In other word, the applied value can be a larger value between 0 and the value of the time offset if the value of the time offset is smaller than 0.

In another example embodiment, if the TOA difference exceeds the first threshold, the terminal device 110-1 may apply the time offset for a MTRP time division multiplexing (TDM) repetition mode. In this way, it can reserve the gap for TRP switch. In some embodiments, for intra-slot repetition, the repetition mode can be enabled by configuring ‘tdmSchemeA’, and the first symbol of the second PDSCH transmission occasion starts after K symbols from the last symbol of the first PDSCH transmission occasion, where K̅ is a higher layer parameter configured by the network device. In this case, the terminal device 110-1 may consider the TOA difference and apply the time offset for MTRP intra-slot repetition. For example, the terminal device 110-1 may always apply the time offset in addition to K̅. Alternatively, the terminal device 110-1 may the larger one between the time offset and K̅. In some embodiments, if K̅ is not configured via the higher layer parameter by the network device, the terminal device 110-1 may assume K̅ equals the time offset. In other embodiments, the time offset may be non-negative. Alternatively, the applied value can be a larger value between 0 and the value of the time offset if the value of the time offset is smaller than 0.

Alternatively, for inter-slot repletion, the repetition mode can be enabled by configuration ‘repetitionNumber’, and the same SLIV is applied for all PDSCH transmission occasions across the repetitionNumber consecutive slots. In this case, the terminal device 110-1 may consider the TOA difference and apply the time offset for MTRP inter-slot repetition. In some embodiments, the terminal device 110-1 may always apply the time offset to the time-domain location of PDSCH transmission in slots associated with the TRP 120-2. Alternatively, the terminal device 110-1 may only apply the time offset when the gap between the last symbol of the n-th PDSCH transmission occasion and the first symbol of the (n+1)-th PDSCH transmission occasion is smaller than the time offset or a predefined time duration.

In an example embodiment, the terminal device 110-1 may reserve a measurement gap to avoid inter-TRP interference. In some embodiments, if the TOA difference between the TRP 120-1 and the TRP 120-2 exceeds a second threshold, or if the TOA difference exceeds a second threshold but is smaller than the first threshold, the terminal device 110-1 may receive a reference signal from the TRP 120-1 at a first symbol. In this case, the terminal device 110-1 may reserve the first symbol and a second symbol which is adjacent to the first symbol as unavailable for the downlink transmission associated with the TRP 120-2. The second threshold may be any suitable value, for example, a cyclic prefix (CP) length. The reference signal can be any suitable types of signals, for example, a CSI-RS or a demodulation reference signal (DMRS). In some other embodiments, if the TOA difference between the TRP 120-1 and the TRP 120-2 exceeds a second threshold, or if the TOA difference exceeds a second threshold but is smaller than the first threshold, the terminal device 110-1 may transmit/receive a physical channel/signal to/from the TRP 120-1 at a first symbol and it may reserve the first symbol and a second symbol which is adjacent to the first symbol as unavailable for transmit/receive a physical channel/signal to/from TRP 120-2. A physical channel may be any suitable channel, for example, one or many of uplink/downlink control channel, uplink/downlink shared channel, uplink/downlink data channel, random access channel, broadcast channel. A physical signal may be any signal, for example, one or many of synchronization signal, CSI-RS, DMRS, Sounding RS, Phase tracking TRS, Positioning RS.

For example, if the transmission of the TRP 120-1 and the transmission of the TRP 120-2 need to be orthogonal, the transmission of the TRP 120-2 on the OFDM symbols (k±on the OFDM symimpacted by the transmission of the TRP 120-1 on the OFDM symbol k. The N can be any suitable integer number. Thus, the OFDM symbol k and the OFDM symbol (k±ym may be reserved as unavailable for the downlink transmission associated with the TRP 120-2.

In some embodiments, the terminal device 110-1 may transmit, to the network device, second capability information of the terminal device 110-1. The second capability information may indicate a first maximum supported number (represented as F1) of fast Fourier transform (FFT) windows. Alternatively or in addition, the second capability information may indicate a second number (represented as F2) of FFT windows supported simultaneously by the terminal device 110-1. For example, the terminal device 110-1 may be able support four different FFT windows but can only apply two FFT windows at the same time. In this case, the terminal device 110-1 may attempt four times for measuring a signal within two time units. Alternatively or in addition, the second capability information is related to the number of receive panels equipped at terminal device 110-1. Alternatively or in addition, the second capability information is related to the number of maximum supported simultaneously active receive panels equipped at terminal device 110-1.

In an example embodiment, if multiple FFT windows are applied to eliminate ISI at the terminal device 110-1 side, the measurement period can be related to the number of FFT windows. In this way, the terminal device 110-1 can support multiple FFT windows to mitigate ISI. For example, for a RS measurement, a longer measurement period can be expected since the terminal device 110-1 may be only capable to apply one FFT window at one time.

In some embodiments, the terminal device 110-1 may transmit third capability information to the network device. The third capability information may indicate whether the terminal device is able to support asynchronous MTRP non-coherent joint transmission (NCJT). In some embodiments, the third capability information may indicate whether the terminal device is able to support asynchronous MTRP CJT. Alternatively, the third capability information may indicate whether the terminal device is able to support fallback to a reliability transmission in accordance with a determination that the TOA difference between the TRP 120-1 and the TRP 120-2 exceeds a threshold. A reliability transmission can be transmission in aforementioned MTRP TDM repetition mode. In this case, in some embodiments, the terminal device 110-1 may transmit third indication which indicates the TOA difference between the TRP 120-1 and the TRP 120-2. Alternatively, the network device may measure the uplink transmission. It requires that the terminal device 110-1 transmits a UL signal in a synchronized way, so the network (multiple TRPs) can obtain the accurate propagation delays (respectively) from the terminal device 110-1. For example, the terminal device 110-1 may transmit UL channels/signals via the same timing advance (TA). Alternatively, the terminal device 110-1 may notify the network the applied difference between TAs used for UL transmissions by different UE transmitting (TX) panels.

The terminal device 110-1 may determine a transmission mode based on the TOA difference. The transmission mode can comprise one of: a CJT transmission mode, a NCJT transmission node or a reliability transmission mode. For example, adaptive transmissions may be in different regions. Depending on maximum acceptable path difference from different TRPs to the terminal device 110-1, region can benefit from MTRP (NCJT) and region (for example, region 810) can be benefit form MTRP (reliability) may be different. In another example, the adopted transmission mode depends on the value of ToA difference, CJT is adopted when ToA difference belongs to a first range, NCJT is adopted when ToA difference belongs to a second range, TDM repetition is adopted when ToA difference belongs to a third range. In some embodiments, transmission mode can be updated explicitly, for example, via dedicated signaling to start CJT/NCJT/reliability transmission. In some embodiments, transmission mode can be updated implicitly, for example, via predefined, the network device configured or the terminal device suggested corresponding relationship between transmission modes and TOA difference.

At block 920, the terminal device 110-1 performs a downlink reception and/or uplink transmission with the TRP 120-2 based on the time offset, if the terminal device 110-1 synchronizes with the TRP 120-1.

The terminal device 110-1 may end the asynchronous MTRP mode. In some embodiments, the terminal device 110-1 may end the asynchronous MTRP mode based on an explicit indication from the network device. For example, the explicit indication may be transmitted in a RRC reconfiguration. The explicit indication may be transmitted in a MAC CE. Alternatively, the explicit indication may be transmitted in in DCI. In other embodiments, the terminal device 110-1 may end the asynchronous MTRP mode based on an implicit indication. For example, the asynchronous MTRP mode may be ended based on a time offset configuration. In other embodiments, the asynchronous MTRP mode may be ended based on a time offset update. In some embodiments, ending the asynchronous MTRP mode can be triggered by UE request.

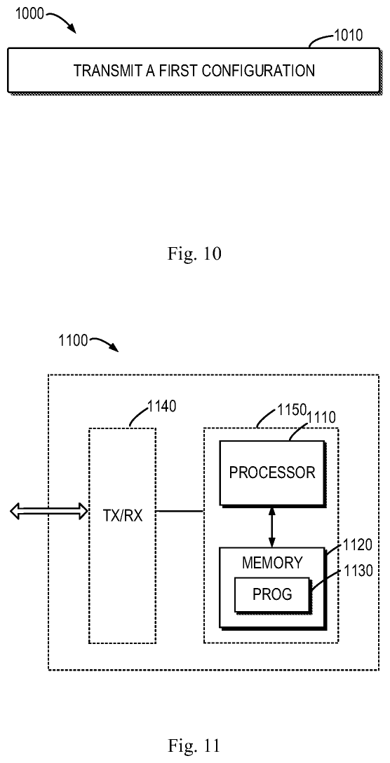

FIG. 10 shows a flowchart of an example method 1000 in accordance with an embodiment of the present disclosure. The method 1000 can be implemented at any suitable devices. Only for the purpose of illustrations, the method 1000 can be implemented at a network device, for example, the TRP 120-1 or the TRP 120-2 as shown in FIG. 1.

In some embodiments, the network device may receive first capability information of the terminal device 110-1 from the terminal device 110-1. In some embodiments, the first capability information may indicate whether the terminal device 110-1 is able to support asynchronous MTRP transmissions from the TRP 120-1 and the TRP 120-2. Alternatively or in addition, the first capability information may indicate a maximum time offset that the terminal device 110-1 is able to support for the asynchronous MTRP transmissions. In some embodiments, the maximum time offset may be a maximum uplink (UL) transmission time offset. Alternatively or in addition, the maximum time offset may be a maximum downlink (DL) reception time offset.

The values of UE capability in the first capability information may depend on numerologies. For example, the terminal device 110-1 may report X time units as the maximum time offset supported for a first SCS, Y time units as the maximum time offset supported for a second SCS, . . . , respectively. Alternatively, the terminal device 110-1 may report X time units as the maximum time offset supported for a first SCS μ1, for a second SCS μ2, a value can be calculated by (2\hat{ }(μ2)/2\hat{ }(μ1))*X or (2\hat{ }(−μ2)/2\hat{ }(−μ1))*X. The time units can be symbols, milliseconds, and the like and the parameter “p” represents the index for numerology. For example, μ=0 refers to 15 KHz SCS, μ=1 refers to 30 KHz SCS, μ=2 refers to 60 KHz SCS, μ=3 refers to 120 KHz SCS, μ=4 refers to 240 KHz SCS, μ=5 refers to 480 KHz SCS, μ=6 refers to 960 KHz SCS, . . . .

In some embodiments, the first capability information does not indicate whether the terminal device 110-1 is able to support the asynchronous MTRP transmissions nor indicate the aforementioned maximum time offset. In this case, the terminal device 110-1 does not support asynchronous MTRP transmissions. Alternatively, the first capability information may indicate that the terminal device 110-1 is able to support the asynchronous MTRP transmissions but does not indicate the aforementioned maximum time offset. In this case, the terminal device 110-1 may support a default value or any value configured. The default value or configured value may depend on numerologies.

At block 1010, the network device transmits a first configuration to the terminal device 110-1. The first configuration indicates a time offset between the TRP 120-1 and the TRP 120-2. The time offset may comprise an UL transmission time offset between the TRP 120-1 and the TRP 120-2 and/or a DL reception time offset between the TRP 120-1 and the TRP 120-2. The first configuration may be transmitted in any suitable signaling, for example, radio resource control (RRC) signaling, system information, broadcasting signaling, etc.

The exact value of the time offset may be related to at least one of the following: a MTRP alignment error, a MTRP transmission path difference, UE panel activation time, or UE panel switch time. For example, the time offset may be determined based on a time alignment error between the TRP 120-1 and the TRP 120-2 to the terminal device 110-1. Alternatively or in addition, the time offset may be determined based on a transmission path difference between the TRP 120-1 and the TRP 120-2. In other embodiments, the time offset may be determined based on a panel activation time of the terminal device 110-1. In a yet embodiment, the time offset can be determined based on a panel switch time of the terminal device 110-1. For example, the time offset can be a symbol-level offset. The time offset may be applied for a reference signal transmission/reception, downlink reception, and/or UL transmission, which will be described later.

In some embodiments, an enabler of the asynchronous MTRP transmission may be introduced. The enabler of the asynchronous MTRP transmission may be a higher layer parameter configured by the network device. The enabler may be set to “off” by default.

The value of the time offset may be related to the time alignment error (TAE). For example, the TAE may refer to a largest timing difference between any two signals belonging to different TRPs. In some embodiments, the TAE can be obtained by over the air (OTA) measurement. Alternatively, the TAE may be a manufacturing parameter.

In some embodiments, the value of the time offset may depend on numerologies. For example, the time offset may be configured as X time units for a first SCS, Y time units for a second SCS, . . . , respectively. Alternatively, the time offset may be configured as X time units for a first SCS μ1, for a second SCS μ2, a value can be calculated by =(2\hat{ }(μ2)/2\hat{ }(μ1))*X or (2\hat{ }(−μ2)/2\hat{ }(−μ1))*X. The time offset may be smaller than the reported UE capability. Alternatively, the time offset may be smaller than a specification-defined requirement. For example, the time offset may be smaller than a maximum transmission/reception timing difference for asynchronous MTRP. The terminal device 110-1 shall be capable of handling a relative transmission/reception timing difference between frame/subframe/slot/symbol timing boundary of a first TRP and the closest frame/subframe/slot/symbol timing boundary of a second TRP which is not synchronized with the first TRP. In some embodiments, the specification-defined requirement values may be numerology-dependent.

In other embodiments, the first configuration may comprise a reference signal (RS) configuration. Alternatively, the first configuration may comprise a transmission configuration indicator (TCI) configuration. In other embodiments, the first configuration may comprise a transmission scheme configuration.

In some embodiments, the network device may transmit a second configuration to the terminal device 110-1. The second configuration may indicate which signal for synchronization associated with the TRP 120-1 and/or TRP 120-2. For example, the signal for synchronization may be a synchronization signal block (SSB), a CSI-RS, a tracking RS or the like. The second configuration may indicate SSB grouping per TRP. In this case, there may be a different transmission power/timing/beamforming gain configured for a different SSB group. In some embodiments, the terminal device 110-1 may measure the signal for synchronization associated with the TRP 120-1 based on the second configuration.

The network device may synchronize with the terminal device 110-1. For example, the synchronization may be performed based on the measurement result of the signal for synchronization.

In some embodiments, the terminal device 110-1 may select a reference TRP. In a situation where the terminal device 110-1 selects the reference TRP, the network device may receive, from the terminal device 110-1, a first indication regarding that the TRP 120-1 as the reference TRP.

Alternatively, the network device may select the reference TRP. In an example embodiment, the network device may select the reference TRP based on the signal arrival time at the network device. For example, if the signal arrives at the TRP 120-1 earlier than the TRP 120-2, the TRP 120-1 may be selected as the reference TRP. In this case, the network device may inform the terminal device 110-1 which TRP is the reference TRP. For example, the network device may transmit 2035 a third configuration regarding that the TRP 120-1 is the reference TRP. The third configuration may indicate that a TRP associated with a specific TCI state (for example, TCI state #0, TCI state with the lowest/highest TCI state ID) can be the reference TRP. Alternatively or in addition, the third configuration can indicate a TRP associated with a specific control resource set (CORESET) (for example, CORESET #0, CORESET with the lowest/highest CORESET ID) can be the reference TRP. In other embodiments, the third configuration can indicate a TRP associated with a specific CORESET pool index (for example, CORESET pool index=0) can be the reference TRP. The network device may receive third information from the terminal device 110-1. The third information may indicate a TOA difference between the TRP 120-1 and the TRP 120-2.

In some embodiments, a terminal device comprises circuitry configured to receive, from a network device, a first configuration indicating a time offset between a first transmission reception point (TRP) and a second TRP, wherein the terminal device is able to support asynchronous multi-TRP (MTRP) transmissions from the first and second TRPs; in accordance with determination that the terminal device synchronizes with the first TRP, perform at least one of: downlink reception or uplink transmission with the second TRP based on the time offset.

In some embodiments, the terminal device comprises circuitry further configured to transmit, to the first TRP, first capability information of the terminal device, wherein the first capability information indicates at least one of: the terminal device being able to support the asynchronous MTRP transmissions, or a maximum time offset that the terminal device is able to support for the asynchronous MTRP transmissions.

In some embodiments, the time offset is determined based on at least one of: a time alignment error between the first TRP and the second TRP, a transmission path difference between the first TRP and the second TRP, a panel activation time of the terminal device, or a panel switch time of the terminal device.

In some embodiments, the terminal device comprises circuitry further configured to receive, from the network device, a second configuration indicating which signal for synchronization associated with the first TRP; and measure a signal for synchronization associated with the first TRP; and the terminal device comprises circuitry further configured to synchronizing with the first TRP by: synchronizing with the first TRP based on a measurement result of the signal for synchronization.

In some embodiments, the terminal device comprises circuitry further configured to transmit, to the network device, a first indication regarding that the first TRP is a reference TRP.

In some embodiments, the terminal device comprises circuitry further configured to receive, from the network device, a third configuration regarding that the first TRP is a reference TRP, wherein the third configuration indicates at least one of: a TRP associated with a transmission configuration indicator (TCI) to be selected as the reference TRP, a TRP associated with a control resource set (CORESET) to be selected as the reference TRP, or a TRP associated with a CORESET pool index to be selected as the reference TRP.

In some embodiments, the terminal device comprises circuitry further configured to start an asynchronous MTRP transmission mode based on at least one of: an explicit indication from the network device, or an implicit indication related to the time offset.

In some embodiments, the terminal device comprises circuitry further configured to in accordance with a determination that a time of arrival (TOA) difference between the first TRP and the second TRP exceeds a first threshold, apply the time offset to a time-domain location of a reference signal (RS) associated with the second TRP; and receive the RS associated with the second TRP based on the time-domain location with the time offset.

In some embodiments, the terminal device comprises circuitry further configured to in accordance with a determination that a time of arrival (TOA) difference between the first TRP and the second TRP exceeds a first threshold, apply the time offset to a channel state information (CSI) computation time; compute a CSI report; and transmit, to the second TRP, the CSI report based on the CSI computation time with the time offset.

In some embodiments, the terminal device comprises circuitry further configured to in accordance with a determination that a time of arrival (TOA) difference between the first TRP and the second TRP exceeds a first threshold, apply the time offset to a beam switching timing for the asynchronous multi-TRP transmissions; and perform a beam switching based on the beam switching timing with the time offset.

In some embodiments, the terminal device comprises circuitry further configured to perform the downlink transmission with the second TRP by: in accordance with a determination that a time of arrival (TOA) difference between the first TRP and the second TRP exceeds a first threshold, applying the time offset to a time-domain location of the downlink transmission for the asynchronous multi-TRP transmissions; and performing the downlink transmission based on the time-domain location with the time offset.

In some embodiments, the terminal device comprises circuitry further configured to in accordance with a determination that a time of arrival (TOA) difference between the first TRP and the second TRP exceeds a first threshold, apply the time offset to a physical downlink shared channel (PDSCH) processing time; and transmit, to the second TRP, a hybrid automatic repeat request (HARQ) feedback of the downlink transmission based on the PDSCH processing time with the time offset.

In some embodiments, the terminal device comprises circuitry further configured to in accordance with a determination that a time of arrival (TOA) difference between the first TRP and the second TRP exceeds a first threshold, apply the time offset to a time duration for Quasi Co-Location (QCL) for the asynchronous multi-TRP transmissions.

In some embodiments, the terminal device comprises circuitry further configured to in accordance with a determination that a time of arrival (TOA) difference between the first TRP and the second TRP exceeds a first threshold, perform a rate match around a symbol for the asynchronous multi-TRP transmissions with the time offset.

In some embodiments, the terminal device comprises circuitry further configured to in accordance with a determination that a time of arrival (TOA) difference between the first TRP and the second TRP exceeds a first threshold, apply the time offset for a MTRP time division multiplexing (TDM) repetition mode.

In some embodiments, the MTRP TDM repetition mode is an intra-slot repetition, and the terminal device comprises circuitry further configured to apply the time offset by: applying the time offset to a gap between a last symbol of a first downlink transmission occasion and a first symbol of a second downlink transmission occasion.

In some embodiments, the MTRP TDM repetition mode is an inter-slot repetition, and the terminal device comprises circuitry further configured to apply the time offset by: in accordance with a determination that a time of arrival (TOA) difference between the first TRP and the second TRP exceeds a first threshold, applying the time offset in a slot associated with the second TRP.

In some embodiments, the MTRP TDM repetition mode is an inter-slot repetition, the terminal device comprises circuitry further configured to apply the time offset by: in accordance with a determination that a time of arrival (TOA) difference between the first TRP and the second TRP exceeds a first threshold and a gap between a last symbol of a first downlink transmission occasion and a first symbol of a second downlink transmission occasion exceeds a predetermined duration, applying the time offset in a slot associated with the second TRP.

In some embodiments, the terminal device comprises circuitry further configured to in accordance with a determination that a time of arrival (TOA) difference between the first TRP and the second TRP exceeds a second threshold but is smaller than a first threshold, receive, from the first TRP, a reference signal at a first symbol; reserve the first symbol and a second symbol which is adjacent to the first symbol as unavailable for the downlink transmission associated with the second TRP.

In some embodiments, the terminal device comprises circuitry further configured to in accordance with a determination that a time of arrival (TOA) difference between the first TRP and the second TRP is smaller than a first threshold and longer than a second threshold, transmit, to the first TRP, second capability information of the terminal device, wherein the second capability information indicates at least one of: a first maximum supported number of fast Fourier transform (FFT) windows, or a second number of FFT windows supported simultaneously by the terminal device.

In some embodiments, the terminal device comprises circuitry further configured to in accordance with a determination that a time of arrival (TOA) difference between the first TRP and the second TRP is smaller than a first threshold and longer than a second threshold, apply a multiplying factor to reference signal measurement period, wherein the multiplying factor is related to the second capability of the terminal device on FFT windows.

In some embodiments, the terminal device comprises circuitry further configured to transmit, to the first TRP, third capability information of the terminal device, wherein the third capability information indicates at least one of: whether the terminal device is able to support asynchronous MTRP non-coherent joint transmission (NCJT), whether the terminal device is able to support asynchronous MTRP CJT, or whether the terminal device is able to support fallback to a reliability transmission in accordance with a determination that a time of arrival (TOA) difference between the first TRP and the second TRP exceeds a threshold.

In some embodiments, the terminal device comprises circuitry further configured to transmit, to the network, third information indicating a time of arrival (TOA) difference between the first TRP and the second TRP.

In some embodiments, the terminal device comprises circuitry further configured to determine a transmission mode based on a time of arrival (TOA) difference between the first TRP and the second TRP, wherein the transmission mode comprises one of: a coherent joint transmission (CJT) transmission mode, a NCJT transmission mode, or a reliability transmission mode.

In some embodiments, a network device comprises circuitry configured to transmit, to a terminal device, a first configuration indicating a time offset between a first transmission reception point (TRP) and a second TRP, wherein the terminal device is able to support asynchronous multi-TRP (MTRP) transmissions from the first and second TRPs.

In some embodiments, the network device comprises circuitry further configured to receive, from the terminal device, first capability information of the terminal device, wherein the first capability information indicates at least one of: the terminal device being able to support the asynchronous MTRP transmissions, or a maximum time offset that the terminal device is able to support for the asynchronous MTRP transmissions.

In some embodiments, the network device comprises circuitry further configured to determine the time offset based on at least one of: a time alignment error between the first TRP and the second TRP, a transmission path difference between the first TRP and the second TRP, a panel activation time of the terminal device, or a panel switch time of the terminal device.

In some embodiments, the network device comprises circuitry further configured to transmit, to the terminal device, a second configuration indicating which signal for synchronization associated with the first TRP.

In some embodiments, the network device comprises circuitry further configured to receive, from the terminal device, a first indication regarding that the first TRP is as a reference TRP.

In some embodiments, the network device comprises circuitry further configured to transmit, to the terminal device, a third configuration regarding that the first TRP is a reference TRP, wherein the third configuration indicates at least one of: a TRP associated with a transmission configuration indicator (TCI) to be selected as the reference TRP, a TRP associated with a control resource set (CORESET) to be selected as the reference TRP, or a TRP associated with a CORESET pool index to be selected as the reference TRP.

FIG. 11 is a simplified block diagram of a device 1100 that is suitable for implementing embodiments of the present disclosure. The device 1100 can be considered as a further example implementation of the terminal device 110 and the network device 120 as shown in FIG. 1. Accordingly, the device 1000 can be implemented at or as at least a part of the terminal device 110 or the TRP 120.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1120 stores at least a part of a program 1130. The TX/RX 1140 is for bidirectional communications. The TX/RX 1140 has at least one antenna to facilitate communication, though in practice an Access Node mentioned in this application may have several ones.

The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

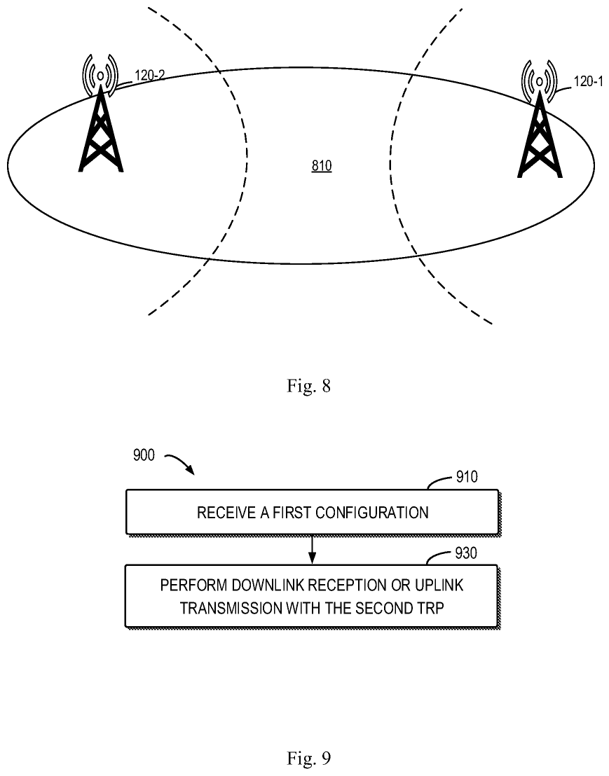

The program 1130 is assumed to include program instructions that, when executed by the associated processor 1110, enable the device 1100 to operate in accordance with the embodiments of the present disclosure, as discussed herein with reference to FIG. 2 to 14. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1550 adapted to implement various embodiments of the present disclosure.

The memory 1120 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 4-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A communication method, comprising:
receiving, at a terminal device and from a network device, a first configuration indicating a time offset between a first transmission reception point (TRP) and a second TRP, wherein the terminal device is able to support asynchronous multi-TRP (MTRP) transmissions from the first and second TRPs; and
in accordance with determination that the terminal device synchronizes with the first TRP, performing, at the terminal device, at least one of: downlink reception with the second TRP based on the time offset or uplink transmission with the second TRP based on the time offset.

2. The method of claim 1, further comprising:
in accordance with a determination that a time of arrival (TOA) difference between the first TRP and the second TRP exceeds a first threshold, applying the time offset to a time-domain location of a reference signal (RS) associated with the second TRP; and
receiving the RS associated with the second TRP based on the time-domain location with the time offset.

3. The method of claim 1, further comprising:
in accordance with a determination that a time of arrival (TOA) difference between the first TRP and the second TRP exceeds a first threshold, applying the time offset to a channel state information (CSI) computation time;
computing a CSI report; and
transmitting, to the second TRP, the CSI report based on the CSI computation time with the time offset.

4. The method of claim 1, further comprising:
in accordance with a determination that a time of arrival (TOA) difference between the first TRP and the second TRP exceeds a first threshold, applying the time offset to a beam switching timing for the asynchronous multi-TRP transmissions; and
performing a beam switching based on the beam switching timing with the time offset.

5. The method of claim 1, wherein performing at least one of: downlink reception or uplink transmission with the second TRP comprises:
in accordance with a determination that a time of arrival (TOA) difference between the first TRP and the second TRP exceeds a first threshold, applying the time offset to a time-domain location of the downlink reception for the asynchronous multi-TRP transmissions; and
performing the downlink reception based on the time-domain location with the time offset.

6. The method of claim 1, further comprising:
in accordance with a determination that a time of arrival (TOA) difference between the first TRP and the second TRP exceeds a first threshold, applying the time offset to a physical downlink shared channel (PDSCH) processing time; and
transmitting, to the second TRP, a hybrid automatic repeat request (HARQ) feedback of the PDSCH based on the PDSCH processing time with the time offset.

7. The method of claim 1, further comprising:
in accordance with a determination that a time of arrival (TOA) difference between the first TRP and the second TRP exceeds a first threshold, applying the time offset to a time duration for Quasi Co-Location (QCL) for the asynchronous multi-TRP transmissions.

8. The method of claim 1, further comprising:
in accordance with a determination that a time of arrival (TOA) difference between the first TRP and the second TRP exceeds a first threshold, performing a rate match around a symbol for the asynchronous multi-TRP transmissions with the time offset.

9. The method of claim 1, further comprising:
in accordance with a determination that a time of arrival (TOA) difference between the first TRP and the second TRP exceeds a first threshold, applying the time offset for a MTRP time division multiplexing (TDM) repetition mode.

10. The method of claim 9, wherein the MTRP TDM repetition mode is an intra-slot repetition, and
wherein applying the time offset comprises:
applying the time offset to a gap between a last symbol of a first downlink reception or uplink transmission occasion and a first symbol of a second downlink reception or uplink transmission occasion.

11. The method of claim 9, wherein the MTRP TDM repetition mode is an inter-slot repetition, and
wherein applying the time offset comprises:
applying the time offset to the time-domain location of downlink reception or uplink transmission in a slot associated with the second TRP.

12. The method of claim 9, wherein the MTRP TDM repetition mode is an inter-slot repetition, and
wherein applying the time offset comprises:
in accordance with a gap between a last symbol of a first downlink reception or uplink transmission occasion and a first symbol of a second downlink reception or uplink transmission occasion exceeds a predetermined duration, applying the time offset in a slot associated with the second TRP.

13. The method of claim 1, further comprising:
in accordance with a determination that a time of arrival (TOA) difference between the first TRP and the second TRP exceeds a second threshold but is smaller than a first threshold, receiving, from the first TRP, a reference signal at a first symbol;
reserving the first symbol and a second symbol which is adjacent to the first symbol as unavailable for the downlink reception or uplink transmission associated with the second TRP.

14. The method of claim 1, further comprising at least one of:
transmitting, to the network device, first capability information of the terminal device, wherein the first capability information indicates at least one of:
the terminal device being able to support the asynchronous MTRP transmissions, or
a maximum time offset that the terminal device is able to support for the asynchronous MTRP transmissions; or
transmitting, to the network device, second capability information of the terminal device, wherein the second capability information indicates at least one of:
a first number of maximum supported fast Fourier transform (FFT) windows, or
a second number of maximum simultaneously supported FFT windows; or
transmitting, to the network device, third capability information of the terminal device, wherein the third capability information indicates at least one of:
whether the terminal device is able to support asynchronous MTRP non-coherent joint transmission (NCJT),
whether the terminal device is able to support asynchronous MTRP CJT, or
whether the terminal device is able to support fallback to a reliability transmission in accordance with a determination that a time of arrival (TOA) difference between the first TRP and the second TRP exceeds a threshold.

15. The method of claim 14, further comprising:
in accordance with a determination that a time of arrival (TOA) difference between the first TRP and the second TRP is smaller than a first threshold and longer than a second threshold, applying a multiplying factor to reference signal measurement period, wherein the multiplying factor is related to the second capability of the terminal device on FFT windows.

16. The method of claim 1, further comprising:
transmitting, to the network device, third information indicating a time of arrival (TOA) difference between the first TRP and the second TRP.

17-22. (canceled)

23. A communication method, comprising:
transmitting, at a network device and to a terminal device, a first configuration indicating a time offset between a first transmission reception point (TRP) and a second TRP, wherein the terminal device is able to support asynchronous multi-TRP (MTRP) transmissions from the first and second TRPs.

24. The method of claim 23, further comprising:
receiving, from the terminal device, first capability information of the terminal device, wherein the first capability information indicates at least one of:
the terminal device being able to support the asynchronous MTRP transmissions, or
a maximum time offset that the terminal device is able to support for the asynchronous MTRP transmissions.

25-29. (canceled)

30. A terminal device comprising:
a processor; and
a memory coupled to the processor and storing instructions thereon, the instructions, when executed by the processor, causing the terminal device to:
receive, from a network device, a first configuration indicating a time offset between a first transmission reception point (TRP) and a second TRP, wherein the terminal device is able to support asynchronous multi-TRP (MTRP) transmissions from the first and second TRPs; and
in accordance with determination that the terminal device synchronizes with the first TRP, perform at least one of: downlink reception with the second TRP based on the time offset or uplink transmission with the second TRP based on the time offset.

31-32. (canceled)

33. The terminal device of claim 30, wherein the terminal device is further caused to at least one of:
transmit, to the network device, first capability information of the terminal device, wherein the first capability information indicates at least one of:
the terminal device being able to support the asynchronous MTRP transmissions, or
a maximum time offset that the terminal device is able to support for the asynchronous MTRP transmissions; or
transmit, to the network device, second capability information of the terminal device, wherein the second capability information indicates at least one of:
a first number of maximum supported fast Fourier transform (FFT) windows, or
a second number of maximum simultaneously supported FFT windows; or
transmit, to the network device, third capability information of the terminal device, wherein the third capability information indicates at least one of:
whether the terminal device is able to support asynchronous MTRP non-coherent joint transmission (NCJT),
whether the terminal device is able to support asynchronous MTRP CJT, or
whether the terminal device is able to support fallback to a reliability transmission in accordance with a determination that a time of arrival (TOA) difference between the first TRP and the second TRP exceeds a threshold.
